(19) United States
(12) Patent Application Publication
(10) Pub. No.: US 2026/0045749 A1
(43) Pub. Date: Feb. 12, 2026

(54) WIRE-WOUND CHARGER, ROTATING ELECTRICAL CONNECTION STRUCTURE THEREOF, AND FORMATION METHOD THEREOF

(71) Applicant: SHENZHEN SHOUNUOXIN ELECTRONICS CO., LTD, Shenzhen (CN)

(72) Inventors: Jun Cai, Shenzhen (CN); Mingshun Shu, Shenzhen (CN); Sihua Hu, Shenzhen (CN)

(73) Assignee: SHENZHEN SHOUNUOXIN ELECTRONICS CO., LTD, Shenzhen (CN)

(21) Appl. No.: 19/294,486

(22) Filed: Aug. 8, 2025

(30) Foreign Application Priority Data
Aug. 9, 2024 (CN) 2024110941753

(51) Int. Cl. H01R 39/64; H02J 7/00

(52) U.S. Cl. CPC H01R 39/64; H02J 7/0042; H01R 2201/26

(57) ABSTRACT

The present invention relates to a wire-wound charger and a rotating electrical connection structure and a formation method thereof. The rotating electrical connection structure comprises two circuit boards, a conductive elastic sheet group and a conductive sheet assembly. The group and the assembly are mounted on one circuit board. The conductive elastic sheet group comprises a plurality of annular elastic sheets, and the conductive sheet assembly comprises a plurality of conductive rings, a plurality of first and second indentation portions are formed between adjacent sheets or adjacent rings, respectively. The circuit boards are respectively provided with hole portions corresponding to the indentation portions. The sheet or ring have a predetermined thickness and is wear resistance, thus providing a long working period. Further, the structure has a high positioning accuracy, is reliable and readily to be formed.

### TECHNICAL FIELD

The present disclosure relates to the technical field of wire-wound chargers, and more particularly to a wire-wound charger and a rotating electrical connection structure and a formation method thereof.

### BACKGROUND

Currently, charging accessories are commonly used for various electronic devices, such as smartphones, tablet computers, etc., which are generally provided with a relatively longer electric wire. For portable carriage, the wire is equipped with a winding mechanism.

The various circuit boards of a wire-wound charging device are usually connected by conductors. For example, a conductor is mounted on one circuit board, and rotates along with the circuit board while the winding wire rotates. The other circuit board is fixed to the device housing and is usually stationary. The circuit board fixed to the device housing is coated with copper foil on one side facing the conductor. The copper foil contacts and electrically connects to the rotating conductor. During the process of the conductor being driven by the winding wire rotation, a surface of the conductor contacts and rubs against the copper foil. Because the copper foil is only micron-level thick, it is easy to wear and has a short working period. If the copper foil is damaged, the electrical connection fails and the charging device fails immediately. Further, the electrical connection requires high positioning accuracy. Therefore, a wire-wound charger and its rotating electrical connection structure and formation method are urgently required to solve the above problems.

### SUMMARY OF THE INVENTION

Therefore, a wire-wound charger, a rotating electrical connection structure and a formation method thereof are provided, which have a working period, high positioning accuracy, is reliable and readily formed.

A rotating electrical connection structure is provided, which comprises a first circuit board, a second circuit board, a conductive elastic sheet group having a predetermined thickness, and a conductive sheet assembly having a predetermined thickness, wherein the conductive elastic sheet group is mounted on the first circuit board and electrically connected to the first circuit board, and the conductive sheet assembly is mounted on the second circuit board and electrically connected to the second circuit board, the conductive elastic sheet group comprises a plurality of annular elastic sheets, and the conductive sheet assembly comprises a plurality of conductive rings, a plurality of first indentation portions are formed between adjacent sheets of the plurality of annular elastic sheets, a plurality of second indentation portions are formed between adjacent rings of the plurality of conductive rings, each annular elastic sheet abuts against and is electrically connected to a corresponding conductive ring, and the first circuit board and the second circuit board are respectively provided with hole portions corresponding to the first indentation portions and the second indentation portions, and the first indentation portions and the second indentation portions are indentations formed by stamping preset connecting ribs between adjacent sheets or rings, respectively.

Preferably, intervals between adjacent sheets of the plurality of annular elastic sheets are uniform and equal to that between adjacent rings of the plurality of conductive rings, the plurality of annular elastic sheets and the plurality of conductive ring have the same annular number and the same annular diameters.

Preferably, the plurality of annular elastic sheets and the first indentation portions are an integrally formed structure, the plurality of conductive rings and the second indentation portions are an integrally formed structure, the plurality of annular elastic sheets and the first indentation portions are made of the same material, and the plurality of conductive rings and the second indentation portions are made of the same material.

Preferably, circumferential width and radial length of the hole portions are respectively larger than those of the corresponding first indentation portions and the second indentation portions, so as to avoid damaging the first circuit board and the second circuit board when the first indentation portion and the second indentation portions are formed.

Preferably, each hole portion is a through hole that penetrates thickness of the first circuit board and the second circuit board, or alternatively is a non-penetrated hole.

Preferably, the conductive elastic sheet group is welded or bonded to the first circuit board, and the conductive sheet assembly is welded or bonded to the second circuit board.

Preferably, the plurality of annular elastic sheets are multi-route annular elastic sheets arranged in concentric circle order, and the plurality of conductive rings are multi-route electrical conductive rings arranged in concentric circle order; each of the annular elastic sheets has a plurality of evenly distributed elastic contact tabs or contact points, and the plurality of elastic contact tabs or contact points on each annular elastic sheet are correspondingly arranged along a circumferential direction.

Preferably, each elastic contact tab or contact point formed on each annular elastic sheet extend toward the corresponding conductive ring, and each of the annular elastic sheets is electrically connected to one corresponding conductive ring through the elastic contact tabs or contact points.

Preferably, the thickness of the conductive elastic sheet group is in the range of 0.1 mm or more, the thickness of the conductive sheet assembly is in the range of 0.1 mm or more, and both the conductive elastic sheet group and the conductive sheet assembly are made of copper.

A wire-wound charger comprises a charger body and a winding mechanism arranged in the charger body, wherein the winding mechanism comprises the above-mentioned rotating electrical connection structure.

Furthermore, a formation method of the aforementioned rotating electrical connection structure comprise the following steps:
initially stamping an original sheet of a conductive elastic sheet group and an original sheet of a conductive sheet assembly to form a conductive elastic sheet group precursor and a conductive sheet assembly precursor, respectively, the conductive sheet assembly precursor comprises a plurality of conductive rings having a predetermined thickness, a plurality of second pre-pressing portions are formed between adjacent rings of the plurality of conductive rings; the conductive elastic sheet group precursor comprises a plurality of annular elastic sheets having a predetermined thickness, and a plurality of first pre-pressing portions are formed between adjacent sheets of the plurality of annular elastic sheets;
forming hole portions on the first circuit board and the second circuit board corresponding to the positions of the first pre-pressing portion and the second pre-pressing portion respectively;
mounting the conductive sheet assembly precursor on the second circuit board and mounting the conductive elastic sheet group precursor on the first circuit board, with each of the second pre-pressing portions and each of the first pre-pressing portions corresponding to the corresponding hollow portions when mounting;
secondary stamping the conductive elastic sheet group precursor and the conductive sheet assembly precursor after mounting, the secondary stamping process comprising punching out or breaking off the second pre-pressing portions and the first pre-pressing portions along indentation marks so as to causing adjacent rings or sheets be isolated from each other, and form a plurality of annular elastic sheets and a plurality of conductive rings, respectively, the first pre-pressing portions and the second pre-pressing portions forming the first indentation portions and the second indentation portions respectively after secondary stamping.

Compared with the traditional arts, the present invention has at least the following beneficial effects. and a formation method thereof are provided

First, because both the conductive elastic sheet group and the conductive sheet assembly are mounted on the first circuit board and the second circuit board, e.g., by a bonding means rather than a printing process or etching process, respectively, and thus have a predetermined thickness, e.g., more than 0.1 mm to replace traditional structure with a micron-level copper foil on the circuit board.

In the process of the winding-type charger rotating electrical connection structure driving the conductive elastic sheet group to rotate, the conductive elastic sheet group changes from frictional contact with the copper foil to frictional contact with the conductive sheet assembly. Since the conductive sheet assembly is thicker than the copper foil, it is less likely to be damaged by wear, has a long service life, and enhanced reliability of the electrical connection. In this structure, when the conductive elastic sheet group rotates along with rotation of winding, it keeps frictional contact with the conductive sheet assembly rather than traditional copper foil. Since the conductive sheet assembly is thicker than the copper foil, it is less likely to be damaged by wear, has a long service life, and enhanced reliability of the electrical connection.

Second, during the formation process of the rotating electrical connection structure, first indentations are formed between adjacent sheets of annular elastic sheets, and second indentations are formed between adjacent rings of the conductive rings. The first indentations and the second indentations are used to ensure the relative position of each sheet or ring to facilitate integrated molding. As such, when the conductive elastic sheet group and the conductive sheet assembly are respectively mounted on the first circuit board and the second circuit board, there is no need to align each ring separately and mount them one by one. The whole can be aligned and mounted at one time with high alignment accuracy. Through stamping, industrial mass production can be achieved, and mature stamping technology can be fully utilized, which greatly improves the operability and convenience of the process, improves product quality, and increases production efficiency. Further, through stamping process, industrial mass production can be achieved, and mature stamping technology can be fully utilized, which greatly improves the operability and convenience of the process, improves product quality, and increases production efficiency.

### BRIEF DESCRIPTION OF DRAWINGS

FIG. 1 is a schematic diagram of the steps of a formation method of a rotating electrical connection structure according to an embodiment of the present invention.

FIG. 2 is a schematic perspective view of a rotating electrical connection structure according to an embodiment of the present invention.

FIG. 3 is a schematic explored view of the rotating electrical connection structure as shown in FIG. 2.

FIG. 4 is a schematic explored view of the rotating electrical connection structure as shown in FIG. 2, seen from another view other than FIG. 3.

FIG. 5 is a schematic perspective view of an assembly of a first circuit board and a conductive elastic sheet group of the rotating electrical connection structure according to the embodiment of the present invention.

FIG. 6 is a schematic perspective view of a mounting assembly of a conductive sheet assembly and a second circuit board in the rotating electrical connection structure according to the embodiment of the present invention.

### REFERENCE NUMERAL DESCRIPTION

1. First circuit board; 2. Second circuit board; 3. Conductive elastic sheet group; 31. First indentation portion; 32. Annular elastic sheet; 4. Conductive sheet assembly; 41. Second indentation portion; 42. Conductive ring; 5. Hole portion; 6. Front cover; 7. Rear cover; 8. Winding reel; 81. First reel surface; 82. Second reel surface; 9. Winding shaft; 10. Charging wire.

### DETAILED DESCRIPTION OF THE INVENTION

The technical solution in embodiments of the present disclosure will be clearly and completely described below with reference to the embodiments of the present disclosure. Apparently, the described embodiments are merely a part, rather than all of the embodiments, of the present disclosure. On the basis of the embodiments in the present disclosure, all other embodiments acquired by those of ordinary skill in the art without creative labor also fall within the scope of protection of the present disclosure.

It is to be noted that all directional indications or positional relationships in the embodiments, for example, center, upper, lower, left, right, vertical, horizontal, inner, outer, and the like, are based on the orientation or positional relationships shown in the accompanying drawings. These terms are merely used for explaining relative position relations, moving conditions, and the like among components in a certain special gesture, rather than indicating or implying that the referred device or component must have a specific orientation or be constructed and operated in a specific orientation. Therefore, these terms should not be seemed as limiting the scope of the present application. Furthermore, the terms, for example, first, second, and third are used for descriptive purposes only and should not be interpreted as indicating or implying relative importance.

In the present disclosure, unless otherwise specified and defined, the terms “connect”, “fix”, and the like shall be understood in a broad sense. For example, “fix” can be fixedly connection or detachable connection or integrated connection; mechanical connection or electrical connection; or direct connection or indirect connection through an intermedium, and internal communication of two components or an interactive relationship of the two components, unless otherwise defined. Those of ordinary skill in the art may understand the specific meanings of the terms in the present disclosure under specific circumstances.

In addition, the technical solutions of the embodiments of the present disclosure may be combined with one another based on implementation by those of ordinary skill in the art. When the technical solutions contradict each other in combination or may not be realized, it is to be considered that there is no combination of the technical solutions, which shall not fall into the protection scope of the present disclosure.

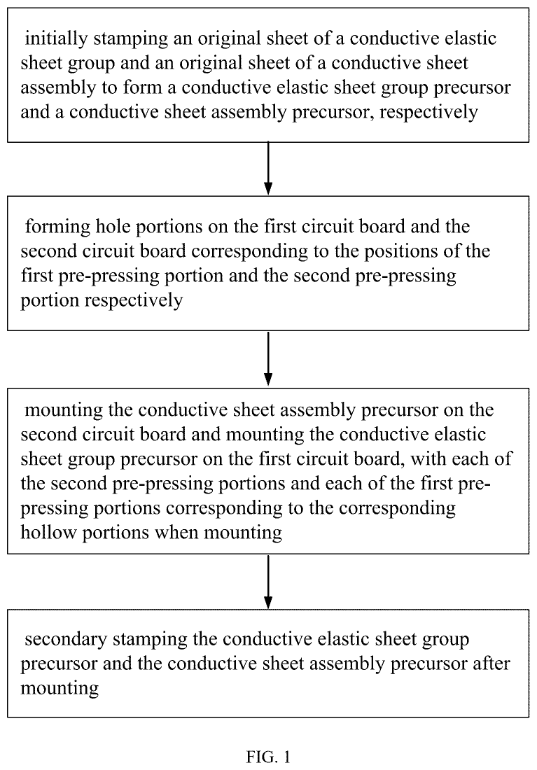

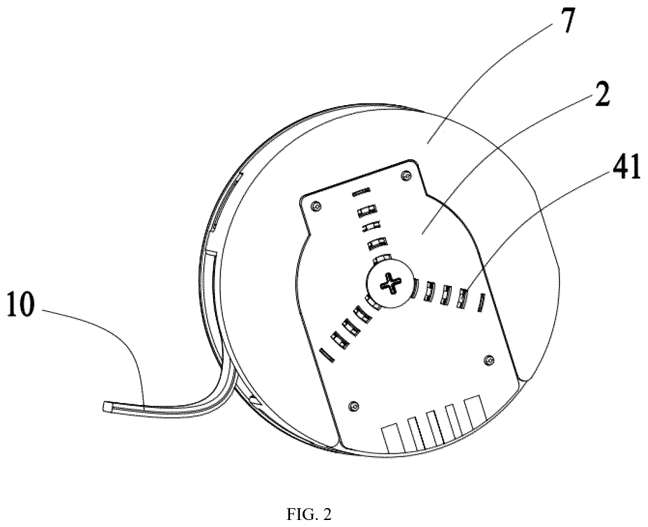

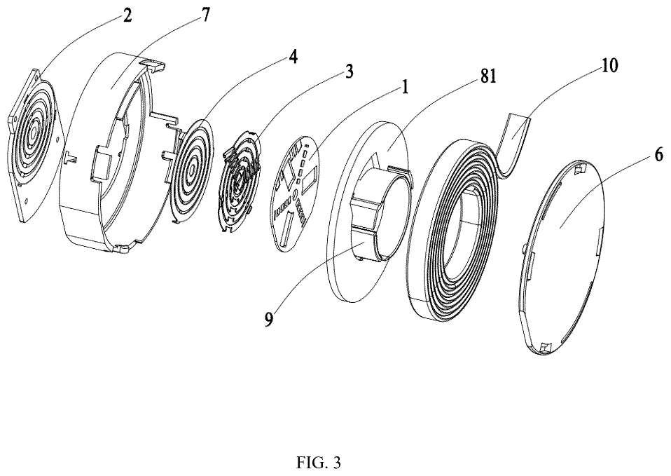

Referring to FIG. 1 through FIG. 6, a rotating electrical connection structure is illustrated, which comprises a first circuit board 1, a second circuit board 2, a conductive elastic sheet group 3 having a predetermined thickness, and a conductive sheet assembly 4 having a predetermined thickness. The conductive elastic sheet group 3 is mounted on the first circuit board 1 and electrically connected to the first circuit board 1, and the conductive sheet assembly 4 is mounted on the second circuit board 2 and electrically connected to the second circuit board 2. The conductive elastic sheet group 3 comprises a plurality of annular elastic sheets 32, and the conductive sheet assembly 4 comprises a plurality of conductive rings 42. A plurality of first indentation portions 31 are formed between adjacent sheets of the plurality of annular elastic sheets 32, a plurality of second indentation portions 41 are formed between adjacent rings of the plurality of conductive rings 42. Each annular elastic sheet 32 abuts against and is electrically connected to a corresponding conductive ring 42, and the first circuit board 1 and the second circuit board 2 are respectively provided with hole portions 5 corresponding to the first indentation portions 31 and the second indentation portions 41, and the first indentation portions 31 and the second indentation portions 41 are indentations formed by stamping preset connecting ribs between adjacent sheets 32 or rings 42, respectively.

Preferably, intervals between adjacent sheets of the plurality of annular elastic sheets 32 are uniform and equal to intervals between adjacent rings of the plurality of conductive rings 42, the plurality of annular elastic sheets 32 and the plurality of conductive ring 42 have the same annular number and the same annular diameters. More preferably, the plurality of annular elastic sheets 32 wholly overlap the plurality of conductive rings 42.

Preferably, the plurality of annular elastic sheets 32 and the first indentation portions 31 are an integrally formed structure, e.g., molded as a whole. The plurality of conductive rings 42 and the second indentation portions 41 are an integrally formed structure, e.g., molded as a whole. The plurality of annular elastic sheets 32 and the first indentation portions 31 are made of the same material, e.g., cooper, aluminum, or other electrical conductive metals, and the plurality of conductive rings 42 and the second indentation portions 41 are made of the same material, e.g., cooper, aluminum, or other electrical conductive metals.

During the integrated stamping process, junctions through which the preset connecting ribs connects to the adjacent conductive rings 42 and the adjacent annular elastic sheets 32 are partially broken. In some optional embodiments, the junctions between the connecting ribs and the ring sidewalls or sheet sidewalls can be broken by ⅓ or ½. After the conductive elastic sheet group 3 and the conductive sheet assembly 4 are mounted on the corresponding circuit board, the unbroken parts are completely punched out by stamping equipment or stamping auxiliary jigs.

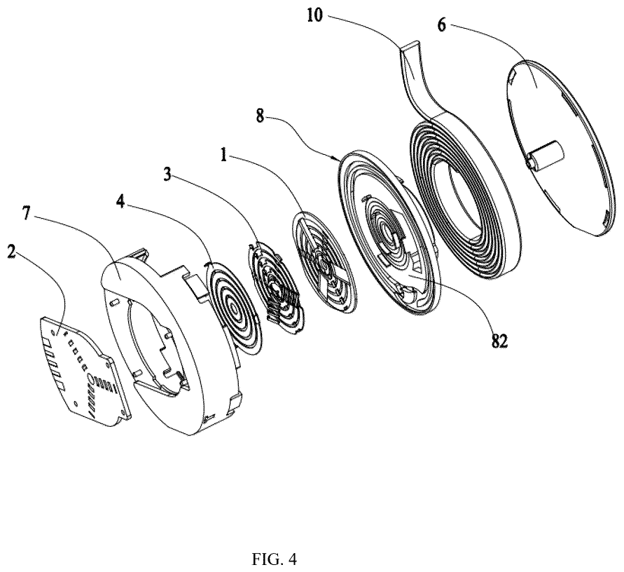

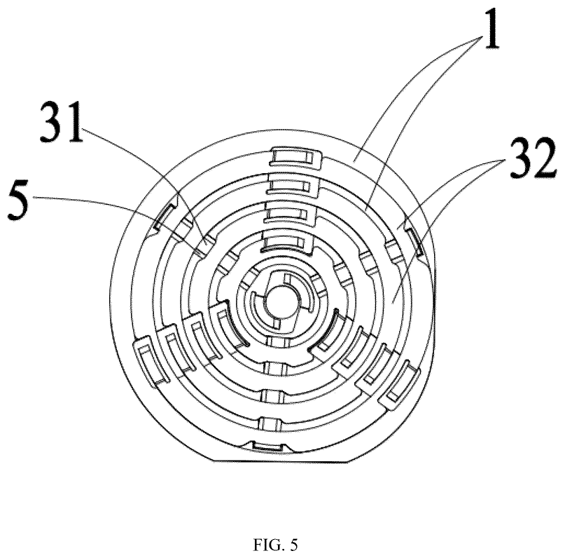

FIG. 4 and FIG. 5 show a state where the connecting ribs are not completely broken. More specifically, the first indentations 31 and the second indentations 41, e.g., remains of the preset connecting ribs, are formed after the connecting ribs are broken, and could be fractured remnants. More specifically, the connecting ribs are at least pre-punched or otherwise formed to form convenient secondary breaking marks, for example, tooth marks or indentations. The breaking marks could be one or two, preferably two. The outer and inter ends of each connecting rib in the radial direction connect the sidewalls of the two adjacent rings 42 or sheets 32. Preferably, the two stamping marks are located at the outer and inter ends where the connecting rib are connected to the sidewalls of the two adjacent rings 42 or sheets 32, so as to ensure isolation between the rings or sheets after breaking.

Preferably, circumferential width and radial length of the hole portions 5 are respectively larger than those of the corresponding first indentation portions 31 and the second indentation portions 41, so as to avoid damaging the first circuit board 1 and the second circuit board 2 when the first indentation portion 31 and the second indentation portions 41 are formed.

Preferably, each hole portion 5 is a through hole that penetrates thickness of the first circuit board 1 and the second circuit board 2, or alternatively is a non-penetrated hole.

Preferably, the conductive elastic sheet group 3 is welded or bonded to the first circuit board 1, and the conductive sheet assembly 4 is welded or bonded to the second circuit board 2. In some specific embodiments, it is preferred to set multiple circles of solder pads on the first circuit board 1 and the second circuit board 2, respectively, and solder paste is evenly applied on each circle of the solder pads. The conductive elastic sheet group 3 and the conductive sheet assembly 4 are fixed to the corresponding solder pads through a reflow soldering process. It is to be understood that the conductive elastic sheet group 3 and the conductive sheet assembly 4 could be attached to the first circuit board 1 and the second circuit board 2 by other mechanism, respectively.

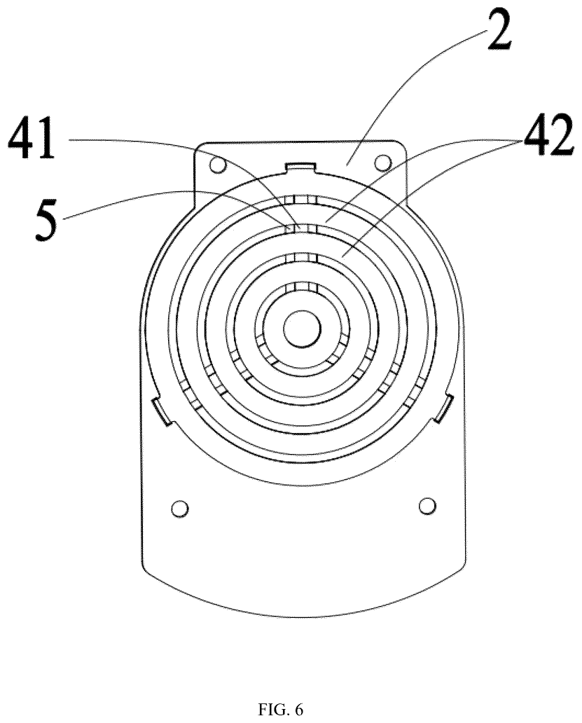

Preferably, the plurality of annular elastic sheets 32 are multi-route annular elastic sheets 32 arranged in concentric circle order, and the plurality of conductive rings 42 are multi-route electrical conductive rings 42 arranged in concentric circle order. Each of the annular elastic sheets 32 has a plurality of evenly distributed elastic contact tabs or contact points, and the plurality of elastic contact tabs or contact points on each annular elastic sheet 32 are correspondingly arranged along a circumferential direction. For example, as shown in FIG. 4, three elastic contacts tabs are provided on each annular elastic sheet 32, and the three positions are evenly distributed on the same sheet at three equal distances. As we known, a charging cable with a connection port, e.g., USB port or Type C port, has a plurality of routes consisting of signal wires and current wires, usually five wires. Accordingly, as shown in FIG. 5 and FIG. 6, five annular elastic sheets 32 and five electrical conductive rings 42 are arranged on the corresponding circuit board in concentric circle order.

Preferably, each elastic contact tab or contact point formed on each annular elastic sheet 32 extend toward the corresponding conductive ring 42, that is, the elastic contact tabs or the contact points are higher than a surface of each annular elastic sheet 32 facing toward the corresponding conductive ring 42. Each of the annular elastic sheets 32 is electrically connected to one corresponding conductive ring 42 through the elastic contact tabs or the contact points. More preferably, as shown in the example of FIG. 4, elastic contact pieces are used, and the elastic contact pieces are provided on the annular elastic sheet 32 of each route. The elastic contact piece extends obliquely from the annular elastic sheet body.

Preferably, the thickness of the conductive elastic sheet group 3 is in the range of 0.1 mm or more, more preferably from 0.1 mm to 0.3 mm. The thickness of the conductive sheet assembly is in the range of 0.1 mm or more, more preferably from 0.1 mm to 0.3 mm. Both the conductive elastic sheet group 3 and the conductive sheet assembly 4 are made of copper.

A wire-wound charger is provided in accordance with another aspect of the present invention, which comprises a charger body and a winding mechanism arranged in the charger body, wherein the winding mechanism comprises the above-mentioned rotating electrical connection structure.

In this embodiment, the charger body could be, e.g., a charging adapter with windings, a charging cable with winder and at least one port connected to a charging adapter, or a vehicle-mounted charging body, which has a built-in winding reel 8 and a charging wire 10 wound around it. Taken a vehicle-mounted charger as an example, when the wire-wound charger is inserted into the cigarette lighter, the charging wire 10 can be extended by pulling the winding reel 8 to facilitate charging over a long distance.

Preferably, the free end of the charging wire 10 can extend at least one charging interface or port, more preferably three charging interfaces, for example, including a USB type-c interface, a Lightning interface, a Micro USB interface, etc.

The the charging wire 10 wound onto the winding reel 8 has a charging end with a USB type-c interface, or a Lightning interface, connecting to a certain electronic terminal, e.g., smartphone or earphone charging case, and so on. The second circuit board 2 is provided with a port which is electrical connected to the plurality of conductive rings 42 and could be connected to a power supply, by a USB cable or a charging adapter.

Specifically, the wire-wound charger further includes a front cover 6 and a rear cover 7, which together form a storage compartment. A winding device is provided in the storage compartment. The winding device includes the above winding reel 8, a winding shaft 9 and a rotating electrical connection structure. The winding reel 8 has a first reel surface 81 and a second reel surface 82. The first reel surface 81 faces the front cover 6, and the second reel surface 82 faces the rear cover 7. A winding shaft 9 is provided at the center of the first reel surface 81, and the charging wire 10 is wound around the winding shaft 9 as the axis.

More specifically, a plurality of circular grooves are provided in the center of the second reel surface 82 to accommodate the first circuit board 1. The second circuit board 2 is detachably connected to the back cover 7. The conductive elastic sheet group 3 is welded or bonded to the first circuit board 1, and the conductive sheet assembly 4 is welded or bonded to the second circuit board 2. Each annular elastic sheet 32 on the conductive elastic sheet group 3 abuts and is electrically connected to the corresponding conductive ring 42 on the conductive sheet assembly 4. When the charging wire 10 is pulled out or retracted, the winding shaft 9 drives the winding reel 8 to rotate, and the winding reel 8 drives the first circuit board 1 on the second reel surface 82 to rotate. During the rotation process, each annular elastic sheet 32 always maintains an electrical connection with the corresponding conductive ring 42.

Furthermore, a formation method of the aforementioned rotating electrical connection structure comprise the following steps. FIG. 1 illustrates a schematic diagram of the main steps of a formation method of the above rotating electrical connection structure.

Step S10, initially stamping an original sheet of a conductive elastic sheet group 3 and an original sheet of a conductive sheet assembly 4 to form a conductive elastic sheet group precursor and a conductive sheet assembly precursor, respectively. Wherein the conductive sheet assembly precursor comprises a plurality of conductive rings 42 having a predetermined thickness, a plurality of second pre-pressing portions are formed between adjacent rings of the plurality of conductive rings 42; the conductive elastic sheet group precursor comprises a plurality of annular elastic sheets 32 having a predetermined thickness, and a plurality of first pre-pressing portions are formed between adjacent sheets of the plurality of annular elastic sheets 32.

In step S10, a precursor of the conductive sheet assembly 4 and a precursor of a precursor of the conductive elastic sheet group 3 are pre-formed. In the two precursors, connecting ribs are provided between the rings or sheets, that is, the rings or sheets in the two precursors are connected as a whole, respectively. This makes it easy to mount them on the corresponding circuit board as a whole. The plurality of conductive rings 42 or the plurality of annular elastic sheets 32 are mounted on the circuit board at one time. There is no need for separate mounting or separate molding of each ring or sheet. The structure of the integrated multiple rings is formed by stamping at one time.

Step S20, forming hole portions 5 on the first circuit board 1 and the second circuit board 2 corresponding to the positions of the first pre-pressing portion and the second pre-pressing portion respectively.

The numbers in each step do not represent the order of precedence. For example, there is no order in which step S10 and step S20 are performed. That is, the process of forming the first pre-pressing portion of the conductive elastic sheet group 3 and the second pre-pressing portion of the conductive sheet assembly 4, and the process of forming the hollow portion 5 of the first circuit board 1 and the second circuit board 2 have no order in which they occur. They can be performed simultaneously or sequentially without affecting each other.

The structure of the hole portions 5 is as described above. The hole portions 5 are preferably formed during the circuit board forming process, or is pre-formed when the board is prefabricated.

Step S30, mounting the conductive sheet assembly 4 precursor on the second circuit board 2 and mounting the conductive elastic sheet group 3 precursor on the first circuit board 1, with each of the second pre-pressing portions and each of the first pre-pressing portions corresponding to the corresponding hollow portions when mounting.

Specifically, in step S30, the mounting of this embodiment is preferably performed by solder welding, and multiple circles of solder pads are preferably set on the first circuit board 1 and the second circuit board 2, and solder paste is evenly applied on each circle of the solder pads. The conductive elastic sheet group 3 and the conductive sheet assembly 4 are fixed to the corresponding solder pads through a reflow soldering process.

Step S40, secondary stamping the conductive elastic sheet group 3 precursor and the conductive sheet assembly 4 precursor after mounting. Wherein the secondary stamping process comprising punching out or breaking off the second pre-pressing portions and the first pre-pressing portions along indentation marks so as to causing adjacent rings or sheets be isolated from each other, and form a plurality of annular elastic sheets 32 and a plurality of conductive rings 42, respectively, the first pre-pressing portions and the second pre-pressing portions forming the first indentation portions 31 and the second indentation portions 41 respectively after secondary stamping.

Specifically, in step S40, the precursor of the conductive sheet assembly 4 and the precursor of the conductive elastic sheet group 3 are punched for the second time. Before the secondary punching, the connecting ribs of the two precursors have been pre-punched into partial fractures in S10, and the upper surface of the connecting rib has indentations or marking cracks, so that the connecting ribs can be completely punched out along the traces during the second punching. Preferably, the connecting ribs are partially broken by ⅓ or ½ before the second punching, and the indentations or marking cracks are located at the outer and inter ends where the connecting ribs are connected to the sidewall of the ring or sheet, so as to ensure isolation between the rings after punching.

### Wire-Wound Charger and a Rotating Electrical Connection Structure and a Formation Method Thereof

In summary, the above-mentioned rotating electrical connection structure adopts the conductive sheet assembly 4, e.g., a copper conductive sheet assembly with a thickness of more than 0.1 mm to replace the micron-level copper foil printed on the traditional circuit board, so that in the process of the winding rotation driving the conductive spring sheet group 3 to rotate, the conductive elastic sheet group 3 changes from friction contact with the copper foil to friction contact with the conductive sheet assembly 4. Since the thickness of the conductive sheet assembly 4 is increased compared to the copper foil, preferably, the same to the conductive elastic sheet group 3, it is less likely to be damaged by wear, has a long service life, and the reliability of the electrical connection is enhanced. Moreover, this forming method adopts first indentation portions 31 between adjacent sheet 32, and second indentation portions 41 between adjacent rings 42. The relative position of each ring or sheet is respectively guaranteed by the first indentation portion 31 and the second indentation portion 41, so as to facilitate the one-piece forming and make the conductive elastic sheet group 3 and the conductive sheet assembly 4 respectively mounted on the first circuit board 1 and the second circuit board 2. There is no need to align each ring separately and mount them one by one, and the whole can be aligned and mounted at one time with high alignment accuracy.

The above is only a preferred embodiment of the disclosure and does not impose any formal limitations on it. Therefore, any simple modifications, equivalent changes, and modifications made to the above embodiments base 10d on the technical essence of the disclosure, which are not separated from the technical solution of the disclosure, shall fall within the scope of protection of the technical solution of the disclosure.

What is claimed is:

1. A rotating electrical connection structure, comprising a first circuit board, a second circuit board, a conductive elastic sheet group, and a conductive sheet assembly, wherein the conductive elastic sheet group have a predetermined thickness and the conductive sheet assembly having a predetermined thickness, the conductive elastic sheet group is mounted on the first circuit board and electrically connected to the first circuit board and the conductive sheet assembly is mounted on the second circuit board and is electrically connected to the second circuit board, the conductive elastic sheet group comprises a plurality of annular elastic sheets, and the conductive sheet assembly comprises a plurality of conductive rings, a plurality of first indentation portions are formed between adjacent sheets of the plurality of annular elastic sheets, a plurality of second indentation portions are formed between adjacent rings of the plurality of conductive rings, each annular elastic sheet abuts against and is electrically connected to a corresponding conductive ring, and the first circuit board and the second circuit board are respectively provided with hole portions corresponding to the first indentation portions and the second indentation portions, and the first indentation portions and the second indentation portions are indentations formed by stamping preset connecting ribs between adjacent sheets or rings, respectively.

2. The rotating electrical connection structure according to claim 1, wherein intervals between adjacent sheets of the plurality of annular elastic sheets are uniform and equal to intervals between adjacent rings of the plurality of conductive rings, and the plurality of annular elastic sheets and the plurality of conductive ring have the same annular number and the same annular diameters, respectively.

3. The rotating electrical connection structure according to claim 1, wherein the plurality of annular elastic sheets and the first indentation portions are an integrally formed structure, the plurality of conductive rings and the second indentation portions are an integrally formed structure, the plurality of annular elastic sheets and the first indentation portions are made of the same material, and the plurality of conductive rings and the second indentation portions are made of the same material.

4. The rotating electrical connection structure according to claim 1, wherein circumferential width and radial length of the hole portions are respectively larger than those of the corresponding first indentation portions and the second indentation portions, so as to avoid damaging the first circuit board and the second circuit board when the first indentation portion and the second indentation portions are formed.

5. The rotating electrical connection structure according to claim 1, wherein each hole portion is a through hole that penetrates thickness of the first circuit board and the second circuit board, or alternatively is a non-penetrated hole.

6. The rotating electrical connection structure according to claim 1, wherein the conductive elastic sheet group is welded or bonded to the first circuit board, and the conductive sheet assembly is welded or bonded to the second circuit board.

7. The rotating electrical connection structure according to claim 1, wherein the plurality of annular elastic sheets are multi-route annular elastic sheets arranged in concentric circle order, and the plurality of conductive rings are multi-route electrical conductive rings arranged in concentric circle order; each of the annular elastic sheets has a plurality of evenly distributed elastic contact tabs or contact points, and the plurality of elastic contact tabs or contact points on each annular elastic sheet are correspondingly arranged along a circumferential direction.

8. The rotating electrical connection structure according to claim 7, wherein each elastic contact tab or contact point formed on each annular elastic sheet extend toward the corresponding conductive ring, and each of the annular elastic sheets is electrically connected to one corresponding conductive ring through the elastic contact tabs or contact points.

9. The rotating electrical connection structure according to claim 1, wherein the thickness of the conductive elastic sheet group is in the range of 0.1 mm or more, the thickness of the conductive sheet assembly is in the range of 0.1 mm or more, and both the conductive elastic sheet group and the conductive sheet assembly are made of copper.

10. A wire-wound charger, comprising a charger body and a winding mechanism arranged in the charger body, wherein the winding mechanism comprises the rotating electrical connection structure according to claim 1.

11. The wire-wound charger according to claim 10, wherein intervals between adjacent sheets of the plurality of annular elastic sheets are uniform and equal to intervals between adjacent rings of the plurality of conductive rings, and the plurality of annular elastic sheets and the plurality of conductive ring have the same annular number and the same annular diameters, respectively.

12. The wire-wound charger according to claim 10, wherein the plurality of annular elastic sheets and the first indentation portions are an integrally formed structure, the plurality of conductive rings and the second indentation portions are an integrally formed structure, the plurality of annular elastic sheets and the first indentation portions are made of the same material, and the plurality of conductive rings and the second indentation portions are made of the same material.

13. The wire-wound charger according to claim 10, wherein circumferential width and radial length of the hole portions are respectively larger than those of the corresponding first indentation portions and the second indentation portions, so as to avoid damaging the first circuit board and the second circuit board when the first indentation portion and the second indentation portions are formed.

14. The wire-wound charger according to claim 10, wherein each hole portion is a through hole that penetrates thickness of the first circuit board and the second circuit board, or alternatively is a non-penetrated hole.

15. The wire-wound charger according to claim 10, wherein the conductive elastic sheet group is welded or bonded to the first circuit board, and the conductive sheet assembly is welded or bonded to the second circuit board.

16. The wire-wound charger according to claim 10, wherein the plurality of annular elastic sheets are multi-route annular elastic sheets arranged in concentric circle order, and the plurality of conductive rings are multi-route electrical conductive rings arranged in concentric circle order; each of the annular elastic sheets has a plurality of evenly distributed elastic contact tabs or contact points, and the plurality of elastic contact tabs or contact points on each annular elastic sheet are correspondingly arranged along a circumferential direction, wherein each elastic contact tab or contact point formed on each annular elastic sheet extend toward the corresponding conductive ring, and each of the annular elastic sheets is electrically connected to one corresponding conductive ring through the elastic contact tabs or contact points.

17. The wire-wound charger according to claim 10, wherein the thickness of the conductive elastic sheet group is in the range of 0.1 mm or more, the thickness of the conductive sheet assembly is in the range of 0.1 mm or more, and both the conductive elastic sheet group and the conductive sheet assembly are made of copper.

18. The wire-wound charger according to claim 10, wherein the charger body is a charging adapter with windings, a charging cable with winder and at least one port connected to a charging adapter, or a vehicle-mounted charging body, and the charger body has a built-in winding reel and a charging wire wound around built-in winding reel, a free end of the charging wire extending at least one charging interface or port, the charging wire wound onto the winding reel has a charging end with a USB type-c interface, or a Lightning interface, configured for connecting to a certain electronic terminal, wherein the wire-wound charger further comprises a front cover and a rear cover which together form a storage compartment with the front cover, a winding device is provided in the storage compartment, the winding device comprises the winding reel, a winding shaft and the rotating electrical connection structure, wherein the winding reel has a first reel surface and a second reel surface, the first reel surface faces the front cover, and the second reel surface faces the rear cover, the winding shaft is provided at the center of the first reel surface, and the charging wire is wound around the winding shaft as the axis.

19. A formation method of the rotating electrical connection structure according to claim 1, comprises the following steps:
initially stamping an original sheet of a conductive elastic sheet group and an original sheet of a conductive sheet assembly to form a conductive elastic sheet group precursor and a conductive sheet assembly precursor, respectively, the conductive sheet assembly precursor comprises a plurality of conductive rings having a predetermined thickness, a plurality of second pre-pressing portions are formed between adjacent rings of the plurality of conductive rings; the conductive elastic sheet group precursor comprises a plurality of annular elastic sheets having a predetermined thickness, and a plurality of first pre-pressing portions are formed between adjacent sheets of the plurality of annular elastic sheets;
forming hole portions on the first circuit board and the second circuit board corresponding to the positions of the first pre-pressing portion and the second pre-pressing portion respectively;
mounting the conductive sheet assembly precursor on the second circuit board and mounting the conductive elastic sheet group precursor on the first circuit board, with each of the second pre-pressing portions and each of the first pre-pressing portions corresponding to the corresponding hollow portions when mounting;
secondary stamping the conductive elastic sheet group precursor and the conductive sheet assembly precursor after mounting, the secondary stamping process comprising punching out or breaking off the second pre-pressing portions and the first pre-pressing portions along indentation marks so as to causing adjacent rings or sheets be isolated from each other, and form a plurality of annular elastic sheets and a plurality of conductive rings, respectively, the first pre-pressing portions and the second pre-pressing portions forming the first indentation portions and the second indentation portions respectively after secondary stamping.

20. The formation method of the rotating electrical connection structure according to claim 19, wherein intervals between adjacent sheets of the plurality of annular elastic sheets are uniform and equal to intervals between adjacent rings of the plurality of conductive rings, and the plurality of annular elastic sheets and the plurality of conductive ring have the same annular number and the same annular diameters, respectively; wherein the plurality of annular elastic sheets and the first indentation portions are an integrally formed structure, the plurality of conductive rings and the second indentation portions are an integrally formed structure, the plurality of annular elastic sheets and the first indentation portions are made of the same material, and the plurality of conductive rings and the second indentation portions are made of the same material; wherein circumferential width and radial length of the hole portions are respectively larger than those of the corresponding first indentation portions and the second indentation portions, so as to avoid damaging the first circuit board and the second circuit board when the first indentation portion and the second indentation portions are formed; wherein each hole portion is a through hole that penetrates thickness of the first circuit board and the second circuit board, or alternatively is a non-penetrated hole; wherein the conductive elastic sheet group is welded or bonded to the first circuit board, and the conductive sheet assembly is welded or bonded to the second circuit board; wherein the plurality of annular elastic sheets are multi-route annular elastic sheets arranged in concentric circle order, and the plurality of conductive rings are multi-route electrical conductive rings arranged in concentric circle order; each of the annular elastic sheets has a plurality of evenly distributed elastic contact tabs or contact points, and the plurality of elastic contact tabs or contact points on each annular elastic sheet are correspondingly arranged along a circumferential direction; wherein each elastic contact tab or contact point formed on each annular elastic sheet extend toward the corresponding conductive ring, and each of the annular elastic sheets is electrically connected to one corresponding conductive ring through the elastic contact tabs or contact points; wherein the thickness of the conductive elastic sheet group is in the range of 0.1 mm or more, the thickness of the conductive sheet assembly is in the range of 0.1 mm or more, and both the conductive elastic sheet group and the conductive sheet assembly are made of copper.
